(19) United States
(12) Patent Application Publication
(10) Pub. No.: US 2026/0278491 A1
(43) Pub. Date: Sep. 17, 2026

(54) DATA COMMUNICATIONS NETWORK AND METHOD TO ASSIST MANAGING NETWORK MARKETING RELATIONSHIPS

(71) Applicant: Amy McIntyre, Leeton (AU)

(72) Inventor: Amy McIntyre, Leeton (AU)

(21) Appl. No.: 19/166,748

(22) PCT Filed: Mar. 21, 2024
(86) PCT No.: PCT/AU2024/050252

§ 371 Date: Sep. 18, 2025

(30) Foreign Application Priority Data
Mar. 21, 2023 (AU) 2023900778

(51) Int. Cl. G06Q 10/0631; G06Q 10/1093; G06Q 30/0201

(52) U.S. Cl. CPC G06Q 10/06311; G06Q 10/1093; G06Q 30/0201

(57) ABSTRACT

A data communications network and a method for operating same for assisting network marketing consultants to manage their network marketing relationships including the ability to schedule and attend remote group meetings that are automatically scheduled and hosted with other individuals associated with direct selling companies. The scheduling accounts for any difference between time zones associated with the marketing consultant location and a time zone associated with the location of each other participating individual. Accordingly, the present invention avoids the requirement for marketing consultants to access and manage relationships with numerous direct selling companies using individual platforms implemented by each company, whilst improving user and resource usage efficiency by utilizing a data structure for real-time display of relevant data during a scheduled meeting and by automatically accounting for the different time zones of participating users according to their geographic location(s).

### FIELD OF THE INVENTION

The present invention relates to a data communications network and a method for operating same for assisting network marketing consultants to manage their network marketing relationships utilising a single application, thereby avoiding the requirement to access and manage relationships with numerous direct selling companies using individual platforms implemented by each company.

### BACKGROUND OF THE INVENTION

The internet has transformed how marketing professionals work and communicate with their peers. Instead of face-to-face meetings or one-on-one telephone calls, the internet has enabled marketing consultants to access, share and transfer information regarding current and future sales activities with their peers across many countries with a connection effected by the internet. This enables marketing meetings and activities to be conducted across the globe, rather than being confined to a local region or area.

The internet has also allowed marketing professionals to increase their product reach, and as a result, marketing consultants now typically manage the marketing and sale of tens, if not hundreds, of products at any given time and possibly for many different manufacturers. However, current systems for accessing information regarding marketing activities relating to a product and/or a particular selling company are generally restricted to individual company portals/platforms, wherein a marketing professional is usually required to access multiple individual company portals/platforms to share messages, conduct meetings and manage their product portfolio and/or customer base. In this regard, activities associated with managing a product portfolio and/or customer base typically include arranging and scheduling meetings with peers and/or customers, sending and receiving messages from their peers and/or customers, receiving alerts in relation to a product or selling company, sharing information with peers, and attending meetings.

The need to access and navigate multiple individual company portals/platforms, has a number of disadvantages. For example, this approach requires marketing consultants to individually log into multiple company portals/platforms to manage their product portfolios and customer base which not only results in reduced efficiency of the marketing consultant, but also results in wastage of computing resources (e.g., processing, memory and networking resources). As another example, to effectively manage their meeting schedule and avoid missing meetings, many marketing consultants elect to manually consolidate various data (eg. meeting times and contact details) from individual company portfolios into a personal calendar which is not only time consuming, but causes a further wastage of computing resources.

Furthermore, since marketing activities are often conducted across the globe, marketing consultants are often required to manually convert meeting times according to their local time-zone, which has an associated risk of capturing incorrect meeting dates and/or times. The need to manage multiple platforms can also result in missed meetings if conflicting meeting times are scheduled with individuals using different calendar functionality associated with individual company portals/platforms. Such errors result in further inefficiencies including additional wastage of computing resources to manage conflicts and/or missed meetings. Furthermore, the risk involved with errors arising as a result of the need to manage data and interactions with peers and customers across multiple individual company portals/platforms is markedly increased since many marketing professionals manage tens, if not hundreds, of products associated with multiple individual selling companies.

The present invention seeks to mitigate the problems discussed herein, or at least seeks to provide an alternative solution to the problems associated with existing computing systems and methods for managing network marketing relationships and the inefficient usage and wastage of computing resources including data communications bandwidth associated with the management of communications between individuals in a marketing relationship.

The reference to any prior art in this specification is not, and should not be taken as, an acknowledgement or any suggestion, that the prior art forms part of the common general knowledge.

### SUMMARY OF THE INVENTION

In one aspect, the present invention provides a data communications network including connected data communications devices and a method of operating same to assist marketing consultants to manage network relationships, the method including, receiving details of a marketing consultant including each direct selling company with whom the marketing consultant has an existing relationship, the details including at least a location of the marketing consultant and one or more individuals associated with each direct selling company, receiving details regarding the marketing consultant's existing customers and associated orders for each customer, the details including any one or more of, placed orders, scheduled delivery times associated with each order, available discounts with respect to each order, a geographic location of each customer, and a sales funnel associated with each customer, storing the marketing consultant and customer details in a database that includes a data structure operable to index the details such that the data structure defines a relationship between each consultant with one or more direct selling companies and each of the consultant's customers, establishing a communication link with one or more processors operably connected to a system of each of the direct selling companies thereby enabling the transmission and receipt of data between the marketing consultant and the one or more individuals associated with each direct selling company, and scheduling and hosting remote group meetings between the marketing consultant and the one or more individuals using the data communications devices of the group meeting attendees, wherein, the data structure is utilised when details relating to any one or more of the marketing consultant, individual(s) and customer(s) are requested to be provided for display on said data communications devices, and providing the requested details in substantially real-time, with the scheduling of the group meeting taking into account any difference between a time zone associated with the marketing consultant location and a time zone associated with a location of each group meeting attendee.

The phrase “sales funnel” within the context of the present invention refers to a visual representation of a customer's journey (a series of stages undertaken by a customer) from first contact with the marketing consultant until a completed purchase (sale)).

In an embodiment, the data structure is automatically populated with details relating to the marketing consultant and their relationship with each direct selling company using one or more artificial intelligence techniques.

In an embodiment, the one or more artificial intelligence techniques includes using natural language processing (NLP) to analyse data retrieved from one or more of email correspondence, text messages and documents associated with the marketing consultant.

In an embodiment, the method further includes using one or more artificial intelligence techniques to identify patterns and/or insights from the consultant's interactions with the individual(s) during the remote group meetings.

In an embodiment, the method further includes generating predictive analytics according to the identified patterns and/or insights, including forecasting potential opportunities or challenges within the relationship between the consultant and the individual(s).

In an embodiment, scheduling and hosting remote group meetings includes, using one or more artificial intelligence techniques to manage the time zone differences including by predicting the most appropriate meeting time for all participants based on analysing one or more of, past meeting preferences, past meeting engagement levels, and real-time changes to participant's schedules or time zones.

In an embodiment, the method further includes aggregating sales data received in relation to each direct selling company engaged by the marketing consultant to enable the consultant to review their sales performance in respect of each direct selling company.

In an embodiment, the method further includes generating a report according to the aggregated sales data, wherein each report includes sales performance details in relation to each company with whom the marketing consultant engages.

In an embodiment, the method further includes, actively monitoring the location of each individual participant scheduled to attend a group meeting.

In an embodiment, the method further includes, generating a notification and/or alerts to individual participants according to any change in relation to another participant's location that includes a change to the time zone in which the other participant is located at the time of a scheduled group meeting.

In an embodiment, the method further includes providing a live chat facility for users including the marketing consultant, individuals and/or customers to engage in spontaneous live chat sessions with other users including the ability to communicate with one or more of, text, graphical icons, and reactions including customisable graphical icons.

In an embodiment, the method further includes prompting the marketing consultant to issue invitations to other users to join the marketing consultant's group.

In an embodiment, the method further includes, in circumstances in which a group of users has been established, providing a communication facility that enables the exchange of messages with other users within the same group.

In an embodiment, the method further includes enabling the marketing consultant to generate and issue notifications to customers regarding any new updates posted by a direct selling company with whom the marketing consultant is engaged, including notifications relating to any one or more of new products, upcoming promotions, stock delays and delivery delays.

In an embodiment, the method further includes enabling the marketing consultant to post information to social media platforms and all customers engaged with consultants according to the social media platforms, wherein each post includes any one or more of, a forthcoming promotion, a forthcoming price reduction, a forthcoming product launch, or updates regarding delivery dates with respect to products and/or services.

In an embodiment, the method further includes enabling the marketing consultant to post information to social media platforms and all customers engaged with consultants according to the social media platforms, wherein each post includes a user activatable link to a live streaming event wherein the recipient may select the link thereby enrolling in the live streaming event and subsequently receive reminders regarding the live streaming event according to the local time zone of the recipient at the time the live streaming event is scheduled to occur.

In an embodiment, the method further includes, enabling advertisers to promote their goods and/or services to users who subscribe to the computer implemented system.

In an embodiment, the method further includes providing a purchasing function for advertisers to upload and post their advertisements and pay a fee according to one or more of the advertisement, the regularity of the advertisement, and the duration for which the advertisement will remain active.

In an embodiment, the method further includes providing a subscription function requiring individual users to pay a subscription on a regular basis to maintain access to the computer implemented system.

In another aspect, the present invention provides a computer-implemented method for assisting marketing consultants to manage network relationships, the method including, receiving, by one or more processors, details of a marketing consultant including each direct selling company with whom the marketing consultant has an existing relationship, the details including at least a location of the marketing consultant and one or more individuals associated with each direct selling company, receiving, by one or more processors, details regarding the marketing consultant's existing customers and associated orders for each customer, the details including any one or more of, placed orders, scheduled delivery times associated with each order, available discounts with respect to each order, a geographic location of each customer, and a sales funnel associated with each customer, storing, by one or more processors, the marketing consultant and customer details in a database that includes a data structure operable to index the details such that the data structure defines a relationship between each consultant with one or more direct selling companies and each of the consultant's customers, establishing, by one or more processors, a communication link with one or more processors operably connected to a system of each of the direct selling companies thereby enabling the transmission and receipt of data between the marketing consultant and the one or more individuals associated with each direct selling company, and scheduling and hosting, by one or more processors, remote group meetings between the marketing consultant and the one or more individuals using the data communications devices of the group meeting attendees, wherein, the data structure is utilised when details relating to any one or more of the marketing consultant, individual(s) and customer(s) are requested to be provided for display on said data communications devices, and providing the requested details in substantially real-time, with the scheduling of the group meeting taking into account any difference between a time zone associated with the marketing consultant location and a time zone associated with the location of each group meeting attendee.

In yet another aspect, the present invention provides a non-transitory computer-readable medium including computer instruction code stored thereon, that when executed on a computer, causes one or more processors of the computer to perform the steps of, receiving details of a marketing consultant including each direct selling company with whom the marketing consultant has an existing relationship, the details including at least a location of the marketing consultant and one or more individuals associated with each direct selling company, receiving details regarding the marketing consultant's existing customers and associated orders for each customer, the details including any one or more of, placed orders, scheduled delivery times associated with each order, available discounts with respect to each order, a geogrpahic location of each customer, and a sales funnel associated with each customer, storing the marketing consultant and customer details in a database that includes a data structure operable to index the details such that the data structure defines a relationship between each consultant with one or more direct selling companies and each of the consultant's customers, establishing a communication link with one or more processors operably connected to a system of each of the direct selling companies thereby enabling the transmission and receipt of data between the marketing consultant and the one or more individuals associated with each direct selling company, and scheduling and hosting remote group meetings between the marketing consultant and the one or more individuals using the data communications devices of the group meeting attendees, wherein, the data structure is utilised when details relating to any one or more of the marketing consultant, individual(s) and customer(s) are requested to be provided for display on said data communications devices, and providing the requested details in substantially real-time, with the scheduling of the group meeting taking into account any difference between a time zone associated with the marketing consultant location and a time zone associated with the location of each group meeting attendee.

Accordingly, the network marketing relationship platform according to the present invention assists consultants to avoid the requirement to access a platform operated by each individual direct selling company for the purpose of receiving notifications, sending messages, raising questions and managing their relationship including meeting times with one or more individuals employed by the individual company with whom the network marketing consultant engages.

The computer implemented system and method of the present invention also provides network marketing consultants with the ability to arrange all of their meetings and to exercise other functions necessary for completion of their tasks with numerous companies whilst only requiring the consultant to access a single platform according to the invention.

Persons skilled in the art will appreciate that by avoiding the need to access multiple individual platforms operated by each direct selling company, the present invention not only increases the efficiency of communications between network marketing consultants with numerous companies, but also provides the technical benefit of reduced usage of computing processing and networking resources as compared with those that would be otherwise be used, since consultants avoid the need to access and work across multiple computing platforms.

### BRIEF DESCRIPTION OF THE DRAWINGS

Embodiments of the invention will now be described in further detail with reference to the accompanying Figures in which:

FIG. 1 provides an overview of a data communications network according to an embodiment of the present invention detailing, in particular, the interaction of various system components;

FIG. 2 illustrates a diagram associated with an exemplary server component of the network illustrated in FIG. 1;

FIG. 3 illustrates an exemplary flow diagram of a process that enables a user (marketing consultant) to download and install a software application, and subsequently access, or register to use, the software application for interaction with the network illustrated in FIG. 1, including providing details relating to direct selling companies with whom the user has an existing relationship and existing customers of the user;

FIG. 4 illustrates an exemplary user interface that enables users to upload additional details regarding their relationship with direct selling companies;

FIG. 5 illustrates an exemplary group meeting interface which enables users to schedule and host remote group meetings with one or more individuals associated with the direct selling companies;

FIG. 6 illustrates a further exemplary user interface which enables users to upload additional details relating to their customers; and

FIG. 7 illustrates a further exemplary interface in the form of a customer engagement and order placement interface that enables the user to engage with customers and enable customers to place orders for particular products provided by direct selling companies.

### DETAILED DESCRIPTION OF EMBODIMENT(S) OF THE INVENTION

For simplicity and illustrative purposes, the present disclosure is described by reference to embodiment(s) thereof. In the following description, numerous specific details are set forth to provide a better understanding of the present disclosure. However, it will be readily apparent that the current disclosure may be practiced without limitation to the specific details. In other instances, some features have not been described in detail to avoid obscuring the present disclosure.

According to an embodiment, the present invention relates to a computer-implemented data communications network and method that assists users (30), namely marketing consultants (30A) and representatives (30B) of direct selling companies (55) with whom the marketing consultants (30A) have an existing relationship (eg. companies such as Amway, Tupperware, Herbalife, AVON, Natura Cosmetics, Mary Kay, Dotura, etc), to manage their network marketing relationships. In particular, this is achieved utilising a single platform, thereby avoiding the need for marketing consultants (30) to access and manage relationships with direct selling companies (55) using the individual platforms of each company.

General reference to “users (30)” herein indicates a reference to either one or both of users (30A) and (30B).

The network and method provide a platform hosting a computer-executable software application (40), wherein the application (40) is accessible by a plurality of users (30), including users (30A) who prefer to connect and engage through the single platform rather than accessing individual platforms operated by each direct selling company (eg. for the purpose of receiving notifications, sending messages, raising questions and managing their relationship including meeting times with one or more individuals (30B) associated with the direct selling companies (55)). The system utilises a central server (20) in communication with data communication devices (50) associated with users (30), as well as devices (50) associated with customers (75) of the marketing consultants (30A).

The central server (20) maintains one or more processors and/or databases for performing functions, including receiving details of a marketing consultant (30A) including each of the direct selling companies (55) with whom the marketing consultant (30A) has an existing relationship, including at least the location of the marketing consultant and one or more individuals associated with each direct selling company, as well as details from the marketing consultant (30A) regarding their existing customers (75). The server (20) may subsequently establish a communication link with one or more processors associated with a hardware system (60) associated with each of the direct selling companies (55) to enable the transmission and receipt of data between the marketing consultant (30A) and each of the direct selling companies (55).

The marketing consultant and customer details may be stored in a database that includes a data structure operable to index the details such that the data structure defines a relationship between each consultant (30A) with one or more particular direct selling companies (55) and each of the consultant's customers (75). The platform further takes into account any time zone difference between a time zone (65) associated with the marketing consultant (30A) and the time zone (70) associated with a direct selling company (55) at the time a remote group meeting (85) between the marketing consultant (30A) and one or more individuals (30B) associated with the direct selling company (55) is scheduled and hosted by the platform. In this regard, the data structure is interrogated to provide details pertaining to users and other participants in substantially real-time.

The skilled person will appreciate that the platform provides a solution to the abovementioned problems associated with conventional network marketing communication techniques since the computer implemented network and method provides a network marketing consultant (30A) with the ability to arrange all of their meetings and to exercise other functions necessary for completion of their tasks with numerous companies (55) through one computer user interface according to an application (40) hosted on the platform, including engagement with their own customers (75).

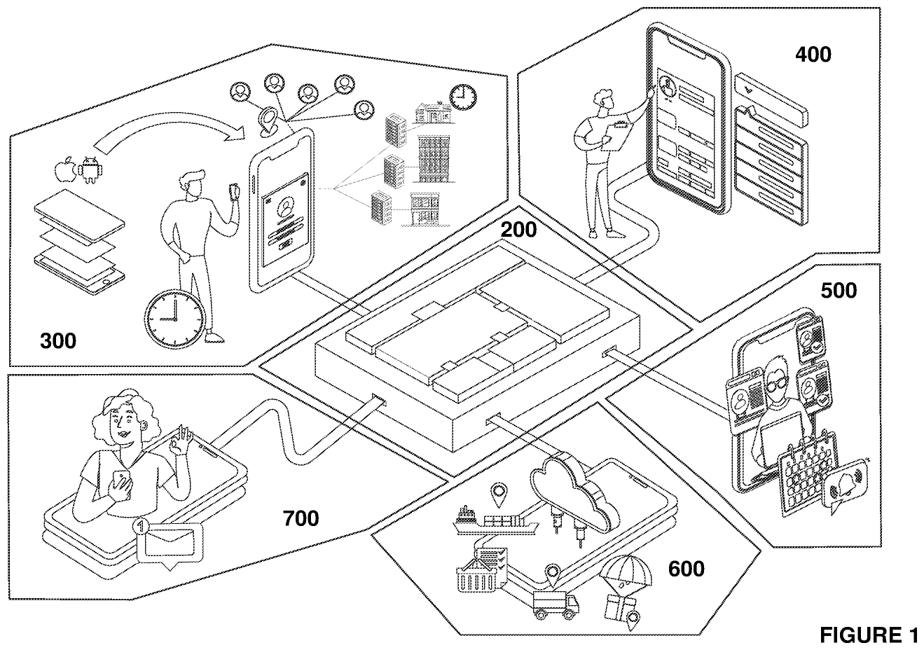

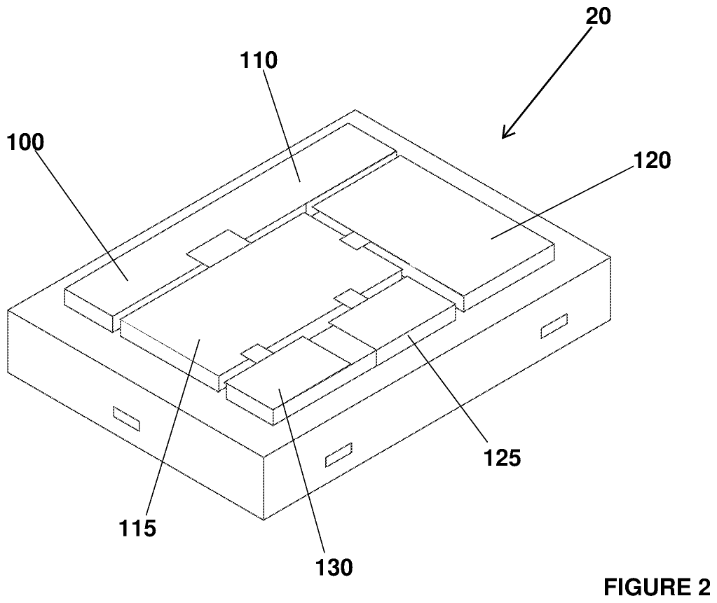

FIG. 1 is divided into Segments which are further expanded in subsequent FIGS. 2 to 7. In particular, Segment 200 of FIG. 1 shows the server component (20) with which the software application (40) operating on each data communications device (50) is configured to communicate. It will be apparent to the person skilled in the relevant field of technology that the software application (40) may be a mobile application or a web application and that, similarly, data communication devices (50) utilised by users (30) as well as customers (75) may be portable devices or fixed location computing devices. Examples of portable devices include mobile phones and computer tablets, and examples of fixed location computing devices include workstations and personal computers. The server component (20) is additionally detailed in FIG. 2.

The skilled person will further appreciate that the steps described herein may be executed by the devices (50), wherein such operations are facilitated via the software application (40) operating on each device (50). According to another implementation, the server (20) may be programmed to provide all, or most, of the processing functions described herein, where they cannot be provided locally on the user devices (50) or where it may be commercially or technically impractical to implement such arrangements. In other words, the steps described herein as performed by the device (50), or components thereof, may be associated with hardware located externally of the device (50) such as the remote central server (20) for example (ie. in a distributed architecture). Different arrangements are possible in this regard, and variations and alternate arrangements will be apparent to the person skilled in the relevant field of technology.

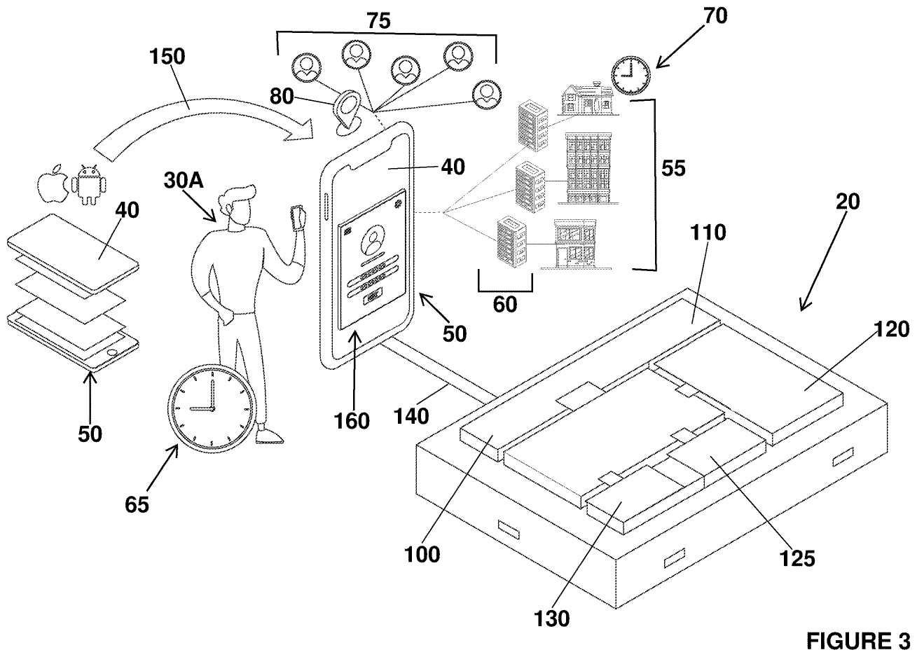

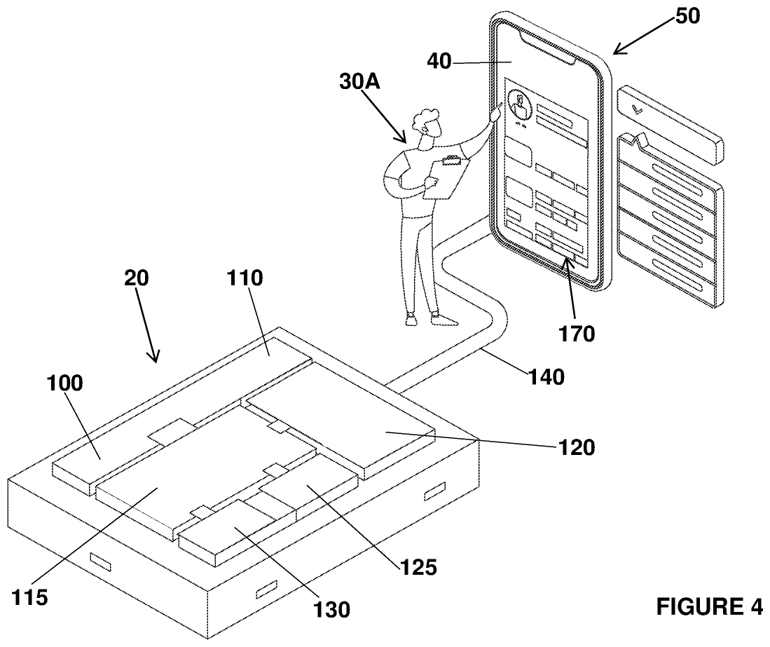

Segment 300 of FIG. 1 depicts a marketing consultant (30A) downloading and installing the application (40) and subsequently accessing the application (40) to establish an account, as further detailed in FIG. 3. Further, Segment 300 shows how the consultant (30A) may upload details relating to each of the direct selling companies (55) with whom the marketing consultant (30A) has a relationship, and details regarding existing customers (75) of the marketing consultant (30A). Segment 400 of FIG. 1 illustrates an interface (170) that enables the marketing consultant (30A) to enter additional details relevant to each individual direct selling company (55) with whom the marketing consultant (30A) has a relationship, including for example, a username and membership number typically used to validate the marketing consultant's connection with the direct selling company (55), as further detailed in FIG. 4.

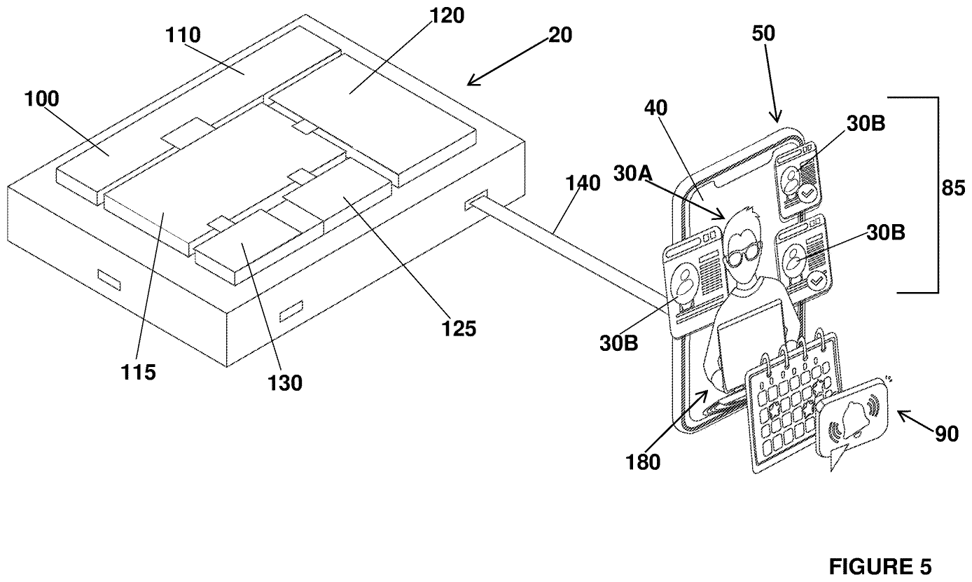

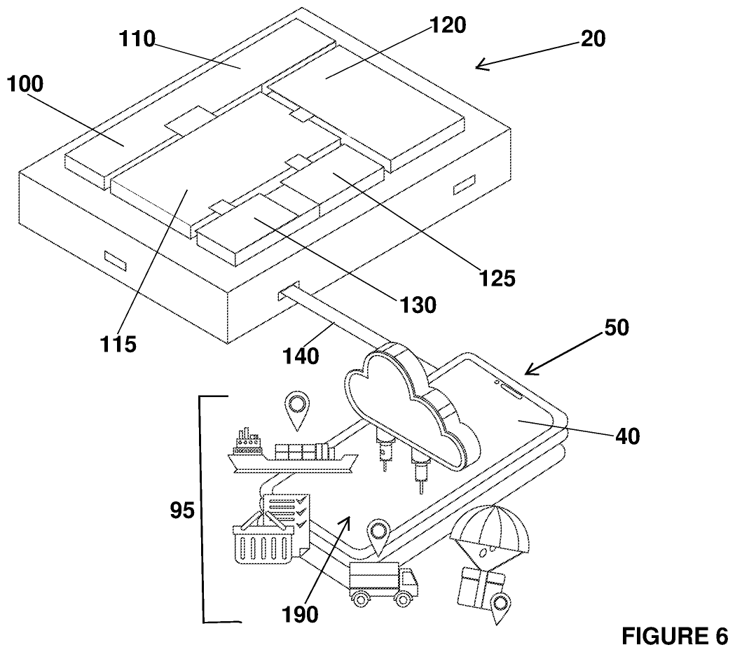

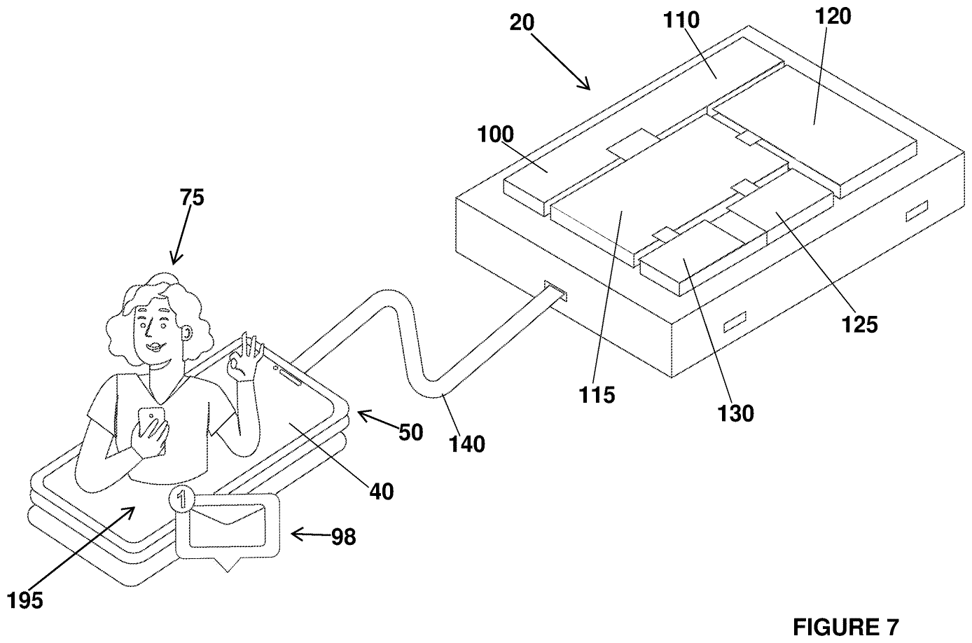

Segment 500 of FIG. 1 illustrates an example of a group meeting interface (180) that enables group meetings to be conducted using the software application (40) and which also enables group meeting reminder alerts (90) to be issued to users (30) based upon meetings that have been scheduled using the platform, as further detailed in FIG. 5. Segment 600 of FIG. 1 illustrates an example interface (190) which enables additional customer details (95) to be uploaded by the marketing consultant (30A), as further detailed in FIG. 6. Finally, Segment 700 of FIG. 1 illustrates a customer engagement and order placement interface (195), as further detailed in FIG. 7.

As mentioned above, FIG. 2 shows in greater detail Segment 200 of FIG. 1 and, in particular, FIG. 2 shows the server component (20) which includes infrastructure (not shown) upon which the platform of the present invention operates. As will be understood by skilled readers, such infrastructure may be local or cloud-based.

The central server (20) may operate one or more computer processors and maintain one or more databases to enable the following functionality and/or storage:
User account register (100) storing user details such as name, age, address, location, contact details, identifiers such as drivers license or passport details of each user (30), and in the case of marketing consultants (30A) details relating to registered customers (75) of each marketing consultant (30A). Where possible, such details may be verified using identification verification services or the like;
Data structure (110) representing an index of consultant details including how each consultant (30A) is linked with one or more particular direct selling companies (55) as well as individual customers (75) of the marketing consultant (30A), such that relationships are defined utilizing the data structure (110). This indexing of data facilitates the subsequent location and retrieval of information, based upon requests input by individual users (30) and/or customers (75), in substantially real-time;
Data processing functionality (115) for processing user input commands and additional data received, and to generate relevant outputs for display. For example, data processing functionality (115) may be responsible for scheduling and enabling the hosting of remote group meetings (85) based on a request for same from a user (30A), including generation of reminder alerts (90) relating thereto, whilst also taking into account any time zone differences between the time zones (65) and (70) associated with the marketing consultant (30A) and individual(s) (30B) associated with direct selling companies (55) respectively;
Meeting reminder/storage facility (120) storing data relating to historical, current and future scheduled meetings including information relating to the attendees, the time of the meeting, and the time span of the meeting, with the ability to generate reminders to relevant users based on scheduling undertaken by the data processing functionality (115);
Search facility (125) that enables any one registered user (30) to search for other users (30) as well as the ability for users (30) to search for scheduled meeting details and/or the like;
Payment gateway (130) that enables financial transactions to be managed through the software application (40) including in relation to subscription fee payments and payments relating to product order requests by customers (75).

FIG. 2 also depicts that server (20) is configured to enable communication (140) with the user devices (50) and, in particular, the software application (40) operating on each user device (50). Such communications may occur via the internet or similar network.

FIG. 3 shows Segment 300 of FIG. 1 in greater detail and, in particular, the steps associated with a user (30A) downloading and installing the application (40) which may be achieved by downloading the application (40) from an application store. Each user (30) may create an account using the application (40) and the account information may be stored in the user account register (100). As described above, the user account register (100) may capture information sufficient to enable each user (30) to be correctly identified. In addition to users (30) (ie. marketing consultant (30A) and representatives (30B) of direct selling companies (55)), the user account register (100) may also store similar details relating to customers (75) of the marketing consultants (30A) who may also be provided access to the platform.

The process of downloading the application (40) is indicated by arrow (150) and interface (160) is also shown in FIG. 3, which allows the user (30A) to download and install the application in order to access the functionality thereof, including to create and maintain a user profile and upload details relating to the direct selling companies (55) as well as the user's customers (75). Accordingly, once the application (40) has been accessed by a user (30A), the user (30A) may be presented with an interface identical, or similar, to interface (160) to allow the user (30A) to create and maintain their account and profile including providing the user (30A) with the ability to add/edit details.

Upon uploading sufficient information, including in relation to the direct selling companies (55) and customers (75), each user (30A) is successfully registered such that the user (30A) becomes a registered user, and the user (30A) may then utilise the functionality of the application (40), which may be in accordance with a subscription level of the user (30A). In this regard, the system may include a subscription function requiring individual users (30) to pay a subscription fee on a regular basis to maintain access to the system. It is to be understood that a similar series of download, installation and registration steps may apply to users other than the marketing consultants (30A), including for example the individuals (30B) and customers (75).

Examples of information that may be received from marketing consultants (30A) in relation to their customers (75) include the name, age, location (80), and contact details of the each customer (75), as well as product related information such as orders that have been placed by customers, scheduled delivery times associated with each order, available discounts with respect to each order, and a sales funnel associated with each customer (75).

The received details may be stored in a database that includes the data structure (110) operable to index the details such that the data structure defines a relationship between each consultant (30A) with one or more direct selling companies (55) and each of the consultant's customers (75). In this regard, the data structure may be automatically populated with details relating to the marketing consultant and their relationship with each direct selling company using one or more artificial intelligence techniques, including but not limited to natural language processing (NLP) to analyse data retrieved from one or more of email correspondence, text messages and documents associated with the marketing consultant.

Once sufficient details have been received, a communication link may be established with one or more processers associated with hardware system(s) (60) associated with each of the direct selling companies (55) nominated by the marketing consultant (30A). It will be appreciated that in many instances, the marketing consultant (30A) will be located in a different part of the world as compared with the direct selling company (55) or individuals (30B) associated therewith. Since the present platform facilitates the scheduling of meetings between such users, involving the transmission and receipt of notifications, messages, questions, answers, etc, it is also necessary to take into account the time zones (65) and (70) associated with the marketing consultant (30A) and representatives (30B) of direct selling companies (55), respectively. By taking into account the difference between the time zones (65) and (70), remote group meetings (85) scheduled and hosted using the platform between the marketing consultant (30A) and the one or more representatives (30B) associated with the direct selling companies (55) will ensure minimal scheduling problems due to individual parties operating in different time zones.

In one example, a marketing consultant (30A) may be based in Australia, and the marketing consultant (30A) may deal with another individual (30B) employed by a direct selling company (55) with whom the marketing consultant (30A) has a relationship, wherein both the individual (30B) and direct selling company (55) are based in the United States. There is clearly a significant time zone difference between Australia and the United States, and one of the benefits of using the present platform is that when a meeting or similar engagement between the two parties is arranged, the platform automatically schedules the engagement taking into account the relative time zones including at the time of generating automatic meeting reminder alerts (90), as described in greater detail below.

FIG. 4 shows in greater detail Segment 400 of FIG. 1 and, in particular, a user interface (170) that enables marking consultants (30A) to enter any additional requested/required details relating to direct selling companies (55) or users (30B) associated therewith. For example, if the user (30A) already has a relationship with the direct selling company (55), it is likely that they will already have a username and password that enables them to gain access to the systems (60) associated with the company (55). The interface (170) may enable the user (30A) to enter such additional detail through interface (170) in order to enable the platform to appropriately integrate with the system(s) (60) associated with the direct selling companies (55).

FIG. 5 shows in greater detail Segment 500 of FIG. 1 and, in particular, an example of a group meeting interface (180) following the scheduling of a remote group meeting (85) between a marketing consultant (30A) and a plurality of individuals (30B) associated with a particular direct selling company (55). It will be appreciated that individual users (30A) may be provided with the ability to issue invitations to others included in their network, including invitations to attend remote group meetings (85). Once particular individuals (30A) and (30B) are connected, the platform may facilitate the exchange of messages between individuals who are members of the same group meeting (85).

According to an embodiment, when a marketing consultant (30A) prepares an invitation, they may suggest one or more times and dates for a particular group meeting (85). When the invitation is sent and received by one or more individuals (30B) associated with the direct selling companies (55), the invitation viewed by each user (30B) already takes into account time zone differences between the users and hence displays an invitation that already indicates a suggested date and time according to the time zone (70) associated with the recipient (30B) of the invitation. This avoids the need for particular times and dates associated with the invitations to be calculated by individual users.

FIG. 5 also shows how meeting reminder alerts (90) may be generated according to scheduled meetings (shown in a calendar in FIG. 5) based upon one or more invitations which have been accepted by individuals (30B). In this regard, the platform may provide such a calendar as a visual display to each registered user wherein the calendar is automatically updated according to scheduled meetings (85). An example of an invitation from a marketing consultant (30A) based in Australia to a particular individual (30B) associated with a direct selling company (55) based in New York may include text such as “John Smith is a marketing consultant in Australia and invites you, as a representative of AMWAY, to a group meeting on the following suggested date/time: 20 March 2023/11:00 am (GMT-5)”.

It will be appreciated that when John Smith initially prepares the invitation, the date and time entered by John Smith will be suitable for him according to his time zone (65) in Australia, whereas the date and time presented in the invitation that is ultimately received by the user (30B) based in New York will be different since it will have been automatically converted into the relevant New York time zone (70) taking into account the present time zone difference and any expected forthcoming changes in view of entering or leaving a daylight saving period. The invitation that is prepared through interface (180) by user (30A) may also include a visual display of the converted date and time that will be presented to user (30B) so that the user (30A) may ensure that the date and time are likely to be appropriate (eg. not in the middle of the night or on a weekend, etc).

Such invitations may be prepared by user (30A) such that the invitation is directed to only users (30B) selected by user (30A). Alternatively, the user (30A) may select to issue such invitations to all individuals (30B) who are registered representatives of a particular direct selling company (55).

Once a meeting has been scheduled, the various time zones associated with the agreed date/time of the meeting may be displayed to the users both in the lead up to and during the meeting. For example, calendar entries that are generated as a result of a scheduled meeting may include the date/time of the proposed meeting associated with all proposed attendees. In other words, the platform may be configured such that the time zone associated with the other user(s) who will be attending the same meeting (85) will be viewable by all, such that all users can see each other's time zones. This will ease the task of arranging the meeting and also editing details relating to the meeting such as changes requested in relation to the date and/or time of the meeting.

In the event a time zone (65/70) associated with any one participant of a scheduled remote group meeting (85) changes, any notifications and/or alerts to individual participants may also automatically update the respective time zones according to the monitored new location of each proposed participant. In other words, the location of each individual scheduled to attend a group meeting (85) may be monitored such that the details regarding notifications and/or alerts to individual participants may be updated according to any change in their location that includes a change to the time zone (65/70) in which individual participants may be located at the time of the scheduled group meeting.

Additional details that may be displayed in such invitations or during group meetings (85) include the name of the attendees, the name of the direct selling company (55) involved, the location of each attendee, the duration of the meeting, the date and time in each relevant location, any particular product types, names, etc being discussed, etc.

One or more artificial intelligence techniques may be utilised to identify patterns and/or insights in the consultant's interactions with other users during remote group meetings (85). For example, predictive analytics may be generated based on the identified patterns and/or insights, including the forecasting of potential opportunities or challenges within relationships between the consultant (30A) and the individual(s) (30B).

FIG. 6 shows in greater detail Segment 600 of FIG. 1 and, in particular, an interface (190) which enables the marketing consultant (30A) to upload any additional details relating to their customers (75) beyond those details initially registered using interface (160). For example, whilst interface (160) may enable the user (30A) to list their customers and customer locations (80), there may well be additional relevant data which the user (30A) prefers to upload in relation to each customer (75). As previously described, this additional information may relate to associated product orders for each customer, including placed orders, scheduled delivery times associated with each order, available discounts with respect to each order, and sales funnels associated with customers (75).

By including these additional details, such information may be easily extracted at the appropriate time and may prove useful during, for example, remote group meetings (85) in which a user (30A) may prefer to direct particular customer information, including sales information, to a representative (30B) of a particular direct selling company (55). In another example, a marketing consultant (30A) may prefer to utilise the platform as a means of managing their customers including monitoring product sales associated therewith, which is facilitated by the ability to utilise the data structure (110) to access customer information in substantially real-time, generate sales reports, etc. In another example, interface (190) may also be used by marketing consultants (30A) to review their personal sales performance and/or that of their team for each direct selling company (55) with whom they have a relationship, and the generation of such information, reports, etc, will be facilitated with the inclusion of data pertaining to the customers of the user (30A). Indeed, sales data pertaining to each direct selling company (55) engaged by a marketing consultant (30A) may be aggregated such that the consultant (30A) may review their personal sales performance and/or that of their team for each direct selling company (55) without the need for particular data from customers (75).

Additional examples of reports that may be generated through interface (190) include reports generated according to aggregated data received from individual companies (55), wherein such reports may include sales performance data in relation to all of the companies with whom the marketing consultant (30A) engages.

Accordingly, a consultant (30A) can view aggregated sales data across all companies with which they engage thereby enabling better performance analysis and generating information that may be used to result in improved strategic planning.

In addition to scheduling group meetings (85), informal types of communication may be established between registered users (30) including for example a live chat facility that may enable, for example, consultant (30A) to engage in a spontaneous live chat sessions with other users (30B) and/or their customers (75), including the ability to communicate with text, graphical icons (eg. emojis), etc. Reaction functionality may also be included with customisable graphical icons (eg. Emojis) thereby promoting an improved user experience. Accordingly, during a product launch for example, consultants (30A) may engage in real-time communications with customers and company representatives to respond to questions and provide information, enhancing customer service and engagement.

FIG. 7 shows in greater detail Segment 700 of FIG. 1 and, in particular, a customer engagement and order placement interface (195) which enables direct communications between the marketing consultant (30A) and each of their customers (75) utilising the functionality of the software application (40), including the ability to receive product orders from customers (75). The interface (195) may also enable automatic reminders to be sent to customers (eg. “Would you like to reorder product X?”). The payment gateway functionality (130) associated with server (20) enables financial transactions relating to the ordering of products by customers (75) to be managed through the software application (40).

There may be circumstances in which customers (75) of the marketing consultant (30A) are not registered to use the software application (40). However, the software application (40) may provide a means by which marketing consultants (30A) may communicate with such customers. For example, an interface (195) may provide functionality enabling consultants (30A) to post information to social media platforms wherein all customers may be engaged by the consultant (30A) according to the social media platform with posts including, but not limited to, information regarding forthcoming promotions, forthcoming price reductions, forthcoming product launches and updates regarding delivery dates with respect to products and/or services. Of course, if customers are registered to use the software application (40), then such information may be accessed directly by the customer (75) through interface (195) without the need to view their social media accounts.

Having regard to the above, the software application (40) may integrate with social media platforms and other external sites to enable consultants (30A) to post messages, including user-activatable links to live streaming events. The recipient customer (75) may select the link thereby enrolling in the live streaming event and subsequently receive reminders regarding the live streaming event according to the local time zone of the recipient at the time the live streaming event is scheduled to occur. It will be appreciated that the platform provides the necessary functionality to enable individual users (marketing consultants) (30A) to generate and issue notifications either directly or indirectly to customers regarding any new updates posted by a direct selling company (55) including, but not limited to, information regarding new products, upcoming promotions, stock delays and delivery delays, etc.

Consultants (30A) can also post information about new products or promotions directly from the platform to social media, broadening their reach and simplifying the promotion process

The platform may also provide advertising functionality such that advertisers may promote their goods and/or services to users who subscribe to the platform, including customers (75), and the payment gateway functionality (130) may also facilitate a purchasing function for such advertisers to upload and post their advertisements and pay an appropriate fee according to the advertisement, the regularity of the advertisement, and the duration for which the advertisement will remain active. This allows for a revenue model within the platform while providing value-added services to consultants (30A), such as advanced analytics or featured advertisements for their services.

The artificial intelligence techniques referenced herein may include, but are not limited to, the predictive analytics capabilities of Google Deepmind and the natural language processing capabilities of OpenAI's Chat-GPT, although it is to be understood that other AU tools may also be used.

The following paragraphs provide examples of scenarios in which the abovementioned AI tools may be used to facilitate functions of the software application (40) described herein:
A marketing consultant may utilize the network and method described herein to manage relationships with multiple direct selling companies including such entities as Avon and Tupperware for example. The use of ChatGPT may automate the entry and updating of company relationship details, while DeepMind may be used to analyze sales data to provide strategic insights for improving sales performance across these relationships.
A marketing consultant may send personalized messages and product recommendations to customers, wherein the messages are generated by ChatGPT according to the customer's purchase history and preferences. DeepMind's predictive analysis may identify which customers are most likely to respond positively to new product launches or promotions.
When planning a meeting with representatives from a cosmetics company, for example, the consultant (30A) may automatically determine the best time for all attendees to virtually meet, considering their time zones and preferences. ChatGPT may generate the meeting agenda according to the objectives described in the consultant's request, and DeepMind may suggest the optimal duration for the meeting based on past successful meetings. These enhancements not only streamline the operational aspects of network marketing but also introduce predictive analytics and personalization that can significantly improve the effectiveness of marketing relationships and strategies, customer engagement, and overall sales performance whilst also significantly improving the efficiency of computer resource usage.

Additional features of the present invention may include but are not limited to:
The ability to manage customer details and orders by automating communications with customers by generating personalized messages, responses to inquiries, and updates regarding orders or promotions. These features enhance customer engagement and satisfaction by ensuring timely and relevant communication.
using reinforcement learning to optimize the sales funnel for each customer according to their interactions and purchasing history. This may involve personalizing product recommendations or identifying the most effective communication strategies to move customers through the sales funnel.
improve the efficiency associated with establishing communication links with direct selling companies (55) by automating the exchange of data. For example, sales reports or order requests may be automatically formatted and sent in the preferred format of each company, reducing manual effort and errors which also improves the efficiency regarding usage of computing resources.
real-time communication may be enhanced by analyzing the content of interactions to provide real-time suggestions or solutions to consultants (30A). For example, during a negotiation with a direct selling company, negotiation tactics or counter-offers may be suggested consistent with successful outcomes from similar past interactions.
the scheduling process may be automated by using natural language processing techniques in relation to requests for meetings, identifying available time slot periods in the prospective attendees calendars, and transmitting invitations with an attached agenda generated from a natural language processed result of the meeting's context.

The advantages of the present invention should now be apparent to persons skilled in the relevant field of technology and particularly those seeking to address the inefficient use of computing resources associated with the arrangement and management of communications between individuals whilst using computing resources and the finite resources of a data communications network. Marketing consultants (30A) are assisted in managing their relationships through a single application, avoiding the need to use multiple platforms hosted by different direct selling companies. Existing arrangements require the consultant (30A) to access several platforms and/or portals to manage customer interactions and sales for different products, leading to inefficiency with respect to both the time of the consultant (30A) and the usage of computing resources. Utilising a data communications network as proposed and method described herein, consultants (30A) can centrally manage these tasks, improving their efficiency with respect to both time and usage of computing resources.

In view of the present system, method and usage of a data communications network as described, there is no longer a requirement for consultants (30A) to manually merge data from different platforms into a single calendar to manage meetings which can lead to errors and missed opportunities. The system, method and usage of a data communications network as described herein automates this process, reducing errors and inefficient resource usage. The consultant (30A) can automatically synchronize meeting schedules across all their network marketing activities, reducing the prospects of scheduling conflicts.

Furthermore, the platform may automatically adjust meeting times for participants in different time zones, ensuring all parties can conveniently attend without requiring manual conversion and update requests. Significantly reduced computing resources are required as consultants (30A) no longer need to operate multiple applications simultaneously, resulting in improved performance of their devices.

As used herein, the term “server”, “system”, “computer”, “computing system” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms.

The one or more processors as described herein are configured to execute a set of instructions that are stored in one or more data storage units or elements (such as one or more memories), in order to process data. For example, the one or more processors may include or be coupled to one or more memories. The data storage units may also store data or other information as desired or needed. The data storage units may be in the form of an information source or a physical memory element within a processing machine.

The set of instructions may include various commands that instruct the one or more processors to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein illustrate one or more control or processing units. It is to be understood that the processing or control units may represent circuits, circuitry, or portions thereof that may be implemented as hardware with associated instructions (eg. software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like.

Optionally, the one or more processors may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in the figures or a described method.

It will be appreciated by persons skilled in the relevant field of technology that numerous variations and/or modifications may be made to the invention as detailed in the embodiments without departing from the spirit or scope of the invention as broadly described. The present embodiments are, therefore, to be considered in all aspects as illustrative and not restrictive.

Throughout this specification and claims which follow, unless the context requires otherwise, the word “comprise”, and variations such as “comprises” and “comprising”, will be understood to imply the inclusion of a stated feature or step, or group of features or steps, but not the exclusion of any other feature or step or group of features or steps.

1. A data communications network comprising connected data communications devices and a method of operating same to assist marketing consultants to manage network relationships, the method comprising:
receiving details of a marketing consultant comprising each direct selling company with whom the marketing consultant has an existing relationship, the details comprising at least a location of the marketing consultant and one or more individuals associated with each direct selling company;
receiving details regarding the marketing consultant's existing customers and associated orders for each customer, the details comprising any one or more of:
placed orders,
scheduled delivery times associated with each order,
available discounts with respect to each order,
a geographic location of each customer, and
a sales funnel associated with each customer;
storing the marketing consultant and customer details in a database that comprises a data structure operable to index the details such that the data structure defines a relationship between each consultant with one or more direct selling companies and each of the consultant's customers;
establishing a communication link with one or more processors operably connected to a system of each of the direct selling companies thereby enabling the transmission and receipt of data between the marketing consultant and the one or more individuals associated with each direct selling company; and
scheduling and hosting remote group meetings between the marketing consultant and the one or more individuals using the data communications devices of the group meeting attendees, wherein:
the data structure is utilised when details relating to any one or more of the marketing consultant, individual(s) and customer(s) are requested to be provided for display on said data communications devices, and providing the requested details in substantially real-time with the scheduling of the group meeting taking into account any difference between a time zone associated with the marketing consultant location and a time zone associated with the location of each group meeting attendee.

2. The data communications network of claim 1, wherein the data structure is automatically populated with details relating to the marketing consultant and their relationship with each direct selling company using one or more artificial intelligence techniques.

3. The data communications network of claim 2, wherein the one or more artificial intelligence techniques comprises using natural language processing (NLP) to analyse data retrieved from one or more of email correspondence, text messages or documents associated with the marketing consultant.

4. The data communications network of claim 1, wherein the method further comprises:
using one or more artificial intelligence techniques to identify patterns and/or insights from the consultant's interactions with the individual(s) during the remote group meetings.

5. The data communications network of claim 4, wherein the method further comprises:
generating predictive analytics according to the identified patterns and/or insights, comprising forecasting potential opportunities or challenges within the relationship between the consultant and the individual(s).

6. The data communications network of claim 1, wherein scheduling and hosting remote group meetings comprises:
using one or more artificial intelligence techniques to manage the time zone differences comprising by predicting the most appropriate meeting time for all participants based on analysing one or more of:
past meeting preferences,
past meeting engagement levels, and
real-time changes to participant's schedules or time zones.

7. The data communications network of claim 1, wherein the method further comprises:
aggregating sales data received in relation to each direct selling company engaged by the marketing consultant to enable the consultant to review their sales performance in respect of each direct selling company.

8. The data communications network of claim 6, wherein the method further comprises:
generating a report according to the aggregated sales data, wherein each report comprises sales performance details in relation to each company with whom the marketing consultant engages.

9. The data communications network of claim 1, wherein the method further comprises:
actively monitoring the location of each individual participant scheduled to attend a group meeting.

10. The data communications network of claim 9, wherein the method further comprises:
generating a notification and/or alerts to individual participants according to any change in relation to another participant's location that comprises a change to the time zone in which the other participant is located at the time of a scheduled group meeting.

11. The data communications network of claim 1, wherein the method further comprises:
providing a live chat facility for users comprising the marketing consultant, individuals and/or customers to engage in spontaneous live chat sessions with other users comprising the ability to communicate with one or more of:
text,
graphical icons,
reactions comprising customisable graphical icons.

12. The data communications network of claim 1, wherein the method further comprises:
prompting the marketing consultant to issue invitations to other users to join the marketing consultant's group.

13. The data communications network of claim 12, wherein, in circumstances in which a group of users has been established, the method further comprises:
providing a communication facility that enables the exchange of messages with other users within the same group.

14. The data communications network of claim 1, wherein the method further comprises enabling the marketing consultant to generate and issue notifications to customers regarding any new updates posted by a direct selling company with whom the marketing consultant is engaged, comprising notifications relating to any one or more of new products, upcoming promotions, stock delays and delivery delays.

15. The data communications network of claim 1, wherein the method further comprises enabling the marketing consultant to post information to social media platforms and all customers engaged with consultants according to the social media platforms, wherein each post comprises any one or more of:
a forthcoming promotion,
a forthcoming price reduction,
a forthcoming product launch, or
updates regarding delivery dates with respect to products and/or services.

16. The data communications network of claim 1, wherein the method further comprises enabling the marketing consultant to post information to social media platforms and all customers engaged with consultants according to the social media platforms, wherein each post comprises a user activatable link to a live streaming event wherein the recipient may select the link thereby enrolling in the live streaming event and subsequently receive reminders regarding the live streaming event according to the local time zone of the recipient at the time the live streaming event is scheduled to occur.

17. The data communications network of claim 1, wherein the method further comprises:
enabling advertisers to promote their goods and/or services to users who subscribe to the computer implemented system.

18. The data communications network of claim 17, wherein the method further comprises:
providing a purchasing function for advertisers to upload and post their advertisements and pay a fee according to one or more of the advertisement, the regularity of the advertisement, and the duration for which the advertisement will remain active.

19. A computer-implemented method for assisting marketing consultants to manage network relationships, the method comprising:
receiving, by one or more processors, details of a marketing consultant comprising each direct selling company with whom the marketing consultant has an existing relationship, the details comprising at least a location of the marketing consultant and one or more individuals associated with each direct selling company;
receiving, by one or more processors, details regarding the marketing consultant's existing customers and associated orders for each customer, the details comprising any one or more of:
placed orders,
scheduled delivery times associated with each order,
available discounts with respect to each order,
a geographic location of each customer, and
a sales funnel associated with each customer;
storing, by one or more processors, the marketing consultant and customer details in a database that comprises a data structure operable to index the details such that the data structure defines a relationship between each consultant with one or more direct selling companies and each of the consultant's customers;
establishing, by one or more processors, a communication link with one or more processors operably connected to a system of each of the direct selling companies to thereby enable the transmission and receipt of data between the marketing consultant and the one or more individuals associated with each direct selling company; and
scheduling and hosting, by one or more processors, remote group meetings between the marketing consultant and the one or more individuals using the data communications devices of the group meeting attendees, wherein:
the data structure is utilised when details relating to any one or more of the marketing consultant, individual(s) and customer(s) are requested to be provided for display on said data communications devices, and providing the requested details in substantially real-time with the scheduling of the group meeting taking into account any difference between a time zone associated with the marketing consultant location and a time zone associated with the location of each group meeting attendee.

20. A non-transitory computer-readable medium comprising computer instruction code stored thereon, that when executed on a computer, causes one or more processors of the computer to:
receive details of a marketing consultant comprising each direct selling company with whom the marketing consultant has an existing relationship, the details comprising at least a location of the marketing consultant and one or more individuals associated with each direct selling company;
receive details regarding the marketing consultant's existing customers and associated orders for each customer, the details comprising any one or more of:
placed orders,
scheduled delivery times associated with each order,
available discounts with respect to each order,
a geographic location of each customer, and
a sales funnel associated with each customer;
store the marketing consultant and customer details in a database that comprises a data structure operable to index the details such that the data structure defines a relationship between each consultant with one or more direct selling companies and each of the consultant's customers;
establish a communication link with one or more processors operably connected to a system of each of the direct selling companies thereby enabling the transmission and receipt of data between the marketing consultant and the one or more individuals associated with each direct selling company; and
schedule and host remote group meetings between the marketing consultant and the one or more individuals using data communications devices of the group meeting attendees, wherein:
the data structure is utilised when details relating to any one or more of the marketing consultant, individual(s) and customer(s) are requested to be provided for display on said data communications devices, and providing the requested details in substantially real-time with the scheduling of the group meeting taking into account any difference between a time zone associated with the marketing consultant location and a time zone associated with the location of each group meeting attendee.
